(19) United States
(12) Patent Application Publication
(10) Pub. No.: US 2012/0253924 A1
(43) Pub. Date: Oct. 4, 2012

(54) SYSTEM AND METHOD FOR GENERATING MARKETING QUALIFIED LEADS USING EMAIL

(76) Inventors: Brian Giese, Bethesda, MD (US); Radhakrishnan Maniyani, Bangalore (IN)

(21) Appl. No.: 13/434,186

(22) Filed: Mar. 29, 2012

Related U.S. Application Data
(60) Provisional application No. 61/468,886, filed on Mar. 29, 2011.

(51) Int. Cl. G06Q 30/02

(52) U.S. Cl. 705/14.48; 705/14.49

(57) ABSTRACT

A system and method for generating marketing leads using email and only charging for the leads generating. The method includes generating a target audience from a database of potential customers and ranking the members of the target audience. The best members of the target audience are sent marketing emails. Based on the responses, additional members of the target audience are sent emails. The method further includes sending out emails until a specific number of the target audience responds thereby generating a marketing lead. The number of marketing leads is determined according to a budget set by a user.

### FIELD

The present disclosure relates to a method of and system for using email to produce marketing qualified leads.

### BACKGROUND

With the increased popularization of the Internet, companies are relying more heavily on online traffic to generate business. Older methods of posting articles in newspapers and phone books to generate business are quickly becoming outdated as people turn to the Internet to look for information and news. Today, companies seek to get listed on search result pages instead of the yellow pages. Companies also employ the use of email to generate business. Companies gather email addresses and send out mass emails in the hope of capturing the attention of prospective customers and generating business.

With these new marketing tools, many marketing companies and systems have been formed that provide expertise and assistance to companies looking to exploit email to generate new business and develop marketing leads. These marketing companies may assist companies by sending emails to prospective clients. Unfortunately, a marketing company's assistance does not always produce the results a company may desire. For example, a marketing company may send out marketing emails to all potential customers of a company and charge the company for every email sent. The cost of such an unfocused marketing scheme can quickly spiral out of control while the company may only see a slight increase in customers.

What is needed is a system that targets good potential customers and only charges for generated marketing qualified leads.

### SUMMARY

The present disclosure provides a method of and system for producing marketing qualified leads of a target audience. The method includes the steps of receiving a marketing message in the form of an email from a user where the email contains a link and receiving an indication of the target audience that includes information concerning the target audience industry, location, company size, and job profile from the user and filtering a database of potential target audience members using a processor based on the received indication of the target audience. Further steps include indicating to the user the size of the target audience based on the received indication of the target audience and receiving a budget from the user indicating the number of marketing qualified leads to generate.

The method also includes parsing relevant words from the marketing message using the processor, building a model based on the received indication of the target audience and the parsed relevant words, and generating marketing qualified leads using a processor. Generating leads includes the steps of using the model to sort through the database of potential target audience members to score each member of the potential target audience, wherein each member of the potential target audience in the database includes information based on feedback from that member and the model uses the information of each member in the database to score that member and comparing the score of each potential target audience member to a relevancy threshold.

Generating leads further includes selecting a potential target audience member having a score above the relevancy threshold as a target member, sending a marketing email to the target member wherein the marketing email includes the marketing message with the link and the target member's name, designating the target member as a market qualified lead if the target member clicks on the link in the marketing email, updating the target member information in the database if the target member clicks on the link in the marketing email, and sending the market qualified lead to the user.

Further in the method for producing the leads, the step of generating marketing qualified leads is repeated for a set time until the number of marketing qualified leads indicated by the budget is generated, wherein during each iteration of generating marketing qualified leads the relevancy threshold is reduced to produce new target members.

The system includes an interface module that interacts with the user and receives the marketing email from the. user. The user also sends information concerning the user's budget and the desired target audience to the interface module. The system also includes a database with information on all potential target audience members. The system constructs a module that filters through the potential target audience members to produce a target member. The system further includes a document module that produces a personalized marketing email for the target member and an email module that sends the personalized marketing email to the target member.

Further areas of applicability of the present disclosure will become apparent from the detailed description provided hereinafter. It should be understood that the detailed description, including disclosed embodiments and drawings, are merely exemplary in nature and intended for purposes of illustration only and are not intended to limit the scope of the invention, its application, or use. Thus; variations that do not depart from the gist of the invention are intended to be within the scope of the invention.

### BRIEF DESCRIPTION OF THE DRAWINGS

FIG. 1 illustrates a system used to generate marketing leads;

FIG. 2 illustrates a method of sorting potential target audience members; and

FIG. 3 illustrates a method of generating marketing qualified leads using target audience members.

### DETAILED DESCRIPTION

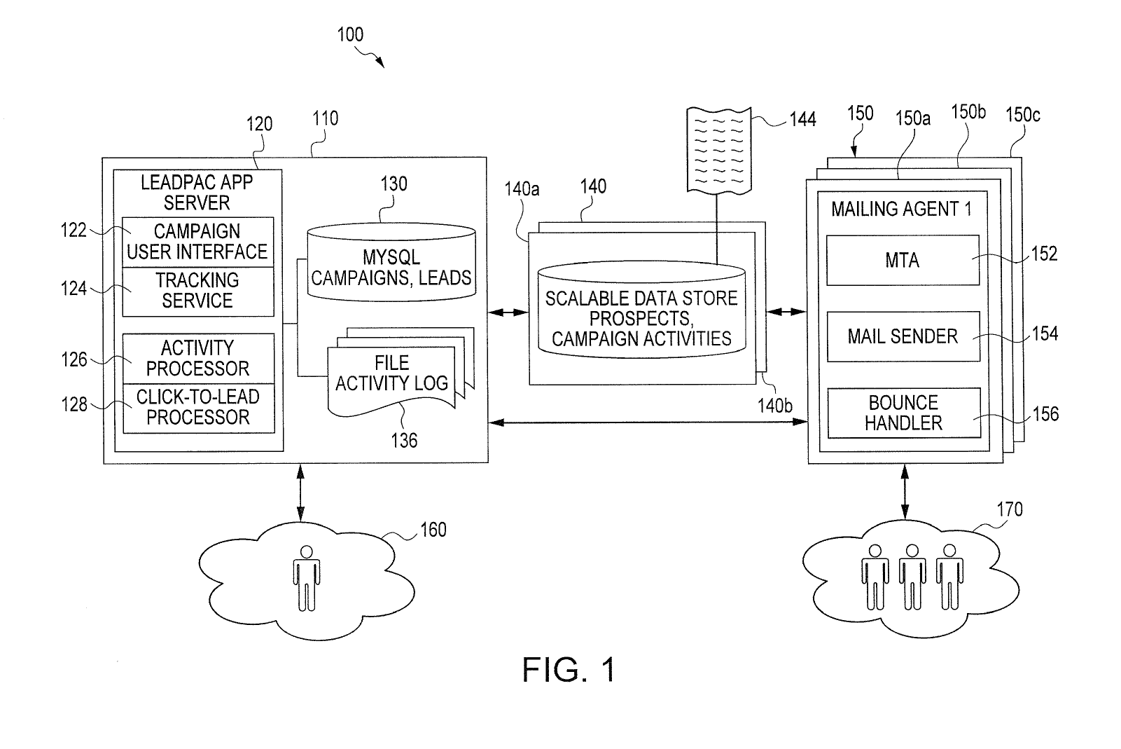

FIG. 1 illustrates a system 100 used to generate marketing qualified leads for a user 160. The system 100 includes a user module 110 that includes an interface system 120 that interfaces the system 100 with the user 160. The interface system 120 includes a user interface module 122, a tracking service module 124, an activity processor 126, and a click-to-lead processor 128. The user interface module 122 interfaces with the user 160 and allows the user 160 to input information into the system 100. The tracking service module 124 monitors and records email activity and activity performed by target audience members 170. The activity processor 126 reads the activity captured by the tracking service module 124. The click-to-lead processor 128 analyzes activity by target audience members 170 and generates marketing qualified leads. The interface system 120 may use a single server, a cluster of servers or other hardware to interface with the user 160 and perform operations based on user instructions and associated software. The user can communicate through a conventional link directly with the module 110 or via an Internet or other network connection. The user can input information on a computer, PDA or other known conventional digital device.

The user module 110 also includes a user information database 130 and activity log files 136. The interface system 120 communicates with the user information database 130 and is able to retrieve information from or send information to the user information database 130. The user information database 130 stores information gathered by, the interface system 120, including information input by the user 160, generated leads, and other information. The user information database 130 may use any one of a number of database system management systems, such as, MySQL, PostgreSQL, Microsoft Access, SQL Server, FileMaker, Oracle, Sybase, dBASE, Clipper, and FoxPro. The user information database 130 may be run on a single computer or server or a cluster of computers or servers. A record of the activity performed by the system 100 is stored in the activity log files 136. The user module 110 is also connected to and communicates with a database 140 that contains information on potential target audience members 144. The user module 110 may be connected with the database 140 over a network or it may be directly connected to the database 140.

The database 140 stores numerous fields of information for each potential target audience member 144. The fields may include, but are not limited to, the potential target audience member's 144 name; work title; email address; work phone; mobile phone; company address; including the city, state, and zip code; number of employees in the company; company revenue; company website; company industry; preferences based on surveys; past responses to email solicitations; previous marketing activities; and any other relevant information. The database 140 may be run on a single computer or server or a cluster of computers or servers e.g. 140a, 140b. The database 140 may use any one of a number of database management systems, such as, Document based, MySQL, PostgreSQL, Microsoft Access, SQL Server, FileMaker, Oracle, Sybase, dBASE, Clipper, and FoxPro.,

The database 140 and user module 110 are also connected to and communicate with an email system. 150. The user module 110 and database 140 may be connected with the email system 150 over a network or it may be directly connected to the email system 150. The email system 150 is used to handle email traffic between the system 100 and target audience members 170. The email system 150 includes a message transfer agent 152, a mail sender 154, and a bounce handler 156. The message transfer agent 152 handles email protocols and the sending of emails to target audience members 170. The mail sender 154 generates emails for each target audience member 170 and determines when the message transfer agent 152 sends emails. The bounce handler 156 handles emails that are not able to be delivered to target audience members 170. The email system 150 may be a server, a cluster of servers 150a-c or other hardware capable of producing emails and handling email traffic and protocols.

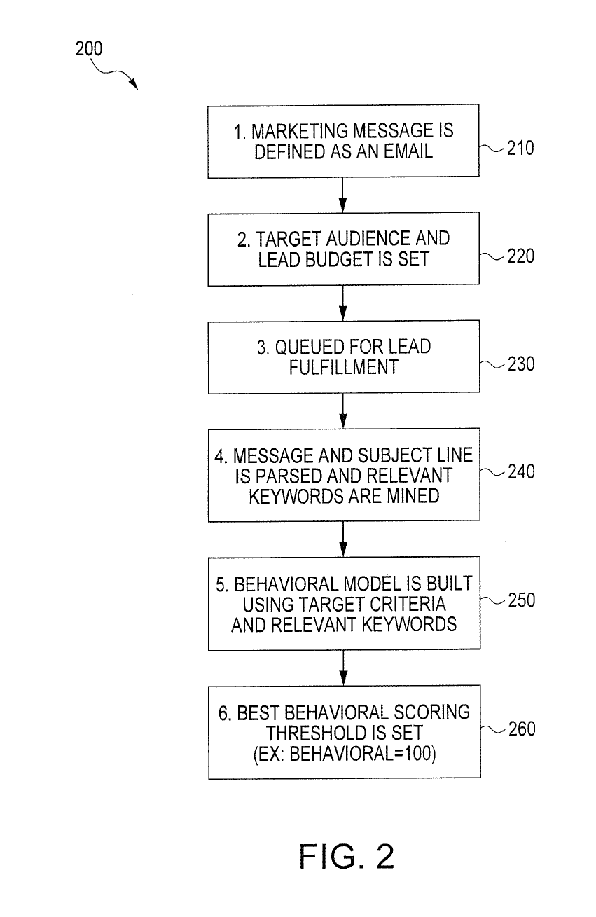

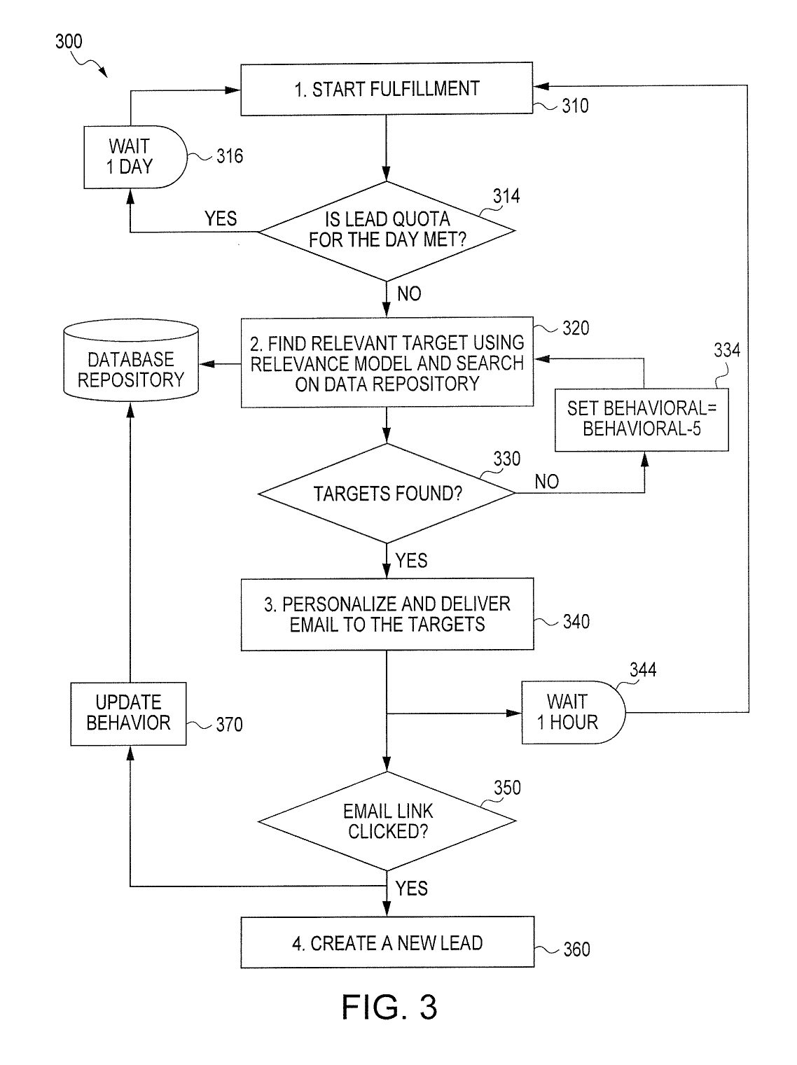

The system 100 uses information input from the user 160, regarding the types of marketing leads that the user 160 desires, to generate marketing qualified leads using email. The information may be received in the form of an Internet file transfer, email, or any other suitable mode of communication. The system 100 only charges the user 160 for the number of generated marketing qualified leads. For example, the user 160 may be a company that sells printer toner to small or mid-size businesses. The system 100 helps the user 160 to find specific individuals at small to mid-size businesses that are in a position to buy printer toner for their business and are interested in buying printer toner. In another example, the user 160 may be a company that wants to sell life insurance to a targeted age group. In this situation, the system 100 helps the user 160 to find specific individuals within a certain age range that are interested in buying life insurance. The specific functions and steps performed by the system 100 are further explained with reference to FIGS. 2 and 3.

FIG. 2 illustrates a modeling process 200 that includes a plurality of steps, implemented using system 100, to sort potential target audience members 144 in the database 140. In step 210, the user 160 interacts with the user interface module 122 over the Internet. The user 160 submits to the user interface module 122 the marketing message. The user 160 may submit the message already prepared in email form with an appropriate subject line by uploading an html file. Alternatively, the user 160 may use an email builder program to generate the marketing message in the form of an email. The user interface module 122 stores the user 160 submitted information in the user information database 130.

The email should include a way for the target audience member 170 to indicate that he or she has interest in the marketing message. For example, the target audience member 170 may indicate his or her interest by responding to the email or forwarding the email to a certain email address. Alternatively, the email may include a link to a white paper, a webinar, a special landing page such as a web form, the user's 160 homepage, or a pass code or other information that the target audience member 170 may enter into a. website. In another example, the email may include instructions for the target audience member 170 to respond via text message or use other forms of social networking. Additionally, the email may have an attachment that may be downloaded and executed to send a message to the user 160 indicating that the target audience member 170 is interested in the marketing message.

Once the user 160 has defined the marketing message in an email, in step 220, the user 160 indicates certain qualities that the target audience members 170 should possess using the user interface module 122. These qualities are stored in the user information database 130. The user 160 may select qualities that correspond to one or more of the fields in the database 140. For example, the user 160 may indicate that it wants target audience members 170 that are chief financial officers in companies that have more than 500 employees and are located in Minnesota. Alternatively, the target audience members 170 may only include females between the ages of 30 and 40 that live in Portland Oregon, own property, and have recently downloaded a white paper on a particular subject. The system 100 may indicate to the user 160 the number of potential target audience members 144 in the database 140 that possess the desired qualities.

During step 220, the user 160 determines how target audience members 170 indicate their interest in the marketing message and become marketing qualified leads. For example, the user 160 may specify that a marketing qualified lead is generated when a target audience member 170 downloads a white paper, signs up for a webinar, completes a web form, clicks on the user's 160 website, sends a text to the user 160, responds to an email, downloads and runs an executable file, or any other way in which the target audience member 170 may express interest in the marketing message. The tracking service module 124 is used to determine when a target audience member 170 performs the required action to indicate interest in the marketing message.

During step 220, the system 100 indicates to the user 160 the cost of each desired marketing qualified lead and allows the user 160 to set a budget according to the number of leads that the user 160 desires. The cost associated with each marketing qualified lead may vary according to the qualities of the target audience members 170 and the manner in which the target audience members 170 indicate their interest in the marketing message. For example, a marketing qualified lead that requires a target audience member 170 to be a CEO and sign-up for a webinar may cost more than a lead that requires the target audience member 170 to be an employee of a mid-size business and click on the user's 160 website. Alternatively, the costs for all marketing qualified leads may be the same. The user 160 may set a daily budget, weekly budget, bi-weekly budget, or a budget for other desired time frames. For example, if the user 160 wants thirty weekly marketing qualified leads that cost ten dollars a piece, the user 160 should set a weekly budget of three hundred dollars. The budget set by the user 160 is stored in the user information database 130.

During step 230, the user 160 directs the system 100 to begin the process 300 of generating marketing qualified leads or indicates a date in the future for the system 100 to begin the process 300 of generating marketing qualified leads. The system 100, once begun, will generate marketing qualified leads until the budget set by the user 160 is spent.

During step 240, the system 100 parses the marketing message submitted by the user 160 and mines relevant keywords that may be used to further narrow the set of target audience members 170. For example, the system 100 may automatically flag all nouns in the marketing message, Alternatively, the system 100 may automatically flag all nouns and adjectives. The flagged words become the relevant keywords.

During step 250, the system 100 builds a model using firmographic factors, geographic factors, and behavioral factors. Firmographic factors include the industry, department and title of potential target audience members 144. Geographic factors include the location of potential target audience members 144, such as, the country, state, county, and zip-code. Behavioral factors include how the potential target audience members 144 have responded to past marketing emails. Each factor is given a separate weight and is scored differently in the model.

The model is used to select the target audience members 170 from the database 140 of potential target audience members 144 by scoring each potential target audience member 144 on a scale from 0 to 100. Specifically, the words in the model are matched with the words in the database 140 for each potential target audience member 144. For each matching word, the relevant weight for the word in the model is recorded. The resulting total weight of the matching words is used to generate the score for that potential target audience member 144. A score of 100 indicates that the potential target audience member 144 meets the criteria specified by the user 160 and is likely to become a marketing qualified lead. A score of zero indicates that the potential target audience member 144 does not meet the specified criteria. A score between 0 and 100 indicates that the potential target audience member 144 may only meet some of the specified criteria. Different scales may be used to score the potential target audience members 144.

During step 260, the system 100 determines a threshold score that is used to determine the minimum score that a potential target audience member 144 needs to become a target audience member 170. The threshold may be set at one hundred or it may be lower.

FIG. 3 illustrates a lead generating process 300 implemented by the system 100. In step 310, the system 100 begins the process 300 of generating marketing qualified leads by determining how many leads to generate in a given day based on the budget set by the user 160. For example, if the user 160 sets a budget of three-hundred dollars per week and each lead costs ten dollars, then the system 100 needs to generate thirty leads per week. The system 100 may partition the leads equally throughout the week. For example, to generate thirty leads, the system 100 may have a quota of 4 leads for 5 days and 5 leads for 2 days. Alternatively, the system 100 may take into account that response rates vary based on the day of the week that the email is sent. For example, the system 100 may recognize that for the user's 160 criteria few to no leads would be generated on a Saturday or Sunday. The system 100 may then set the quota for these days to zero. The system 100 may then set the quota to six leads for the remaining five days of the week. The system 100 may further adjust the quota for each day if too many or too few leads are generated on a given day.

In step 314, the system 100 determines if the lead quota for the day has been met. If the quota has been met, then the process 300 proceeds to step 316. In step 316, the system 100 waits one day, or another predetermined time period, before beginning the process 300 anew. If the quota for the day has not been met, then the process 300 proceeds to step 320. In step 320, the system 100 uses the developed model to score the potential target audience members 144 in the database 140. In step 330, the scores of the potential target audience members 144 are compared to the threshold score. If the potential target audience members 144 scores are above the threshold, then the potential target audience members 144 are designated as target audience members 170 and the process 300 proceeds to step 340. If, however, no potential target audience members 144 score above the threshold, in step 334, the threshold score is reduced. The threshold score may be reduced by increments of five. Once the threshold score is reduced, the process 300 proceeds to repeat step 320, 330, and 334 until target audience members 170 are designated.

In step 340, the mail sender 154 generates personalized emails for each target audience member 170 using the marketing message submitted by the user 160. The mail sender 154 may personalize the message by addressing the person by name. Other aspects of the message may be personalized based on the information in the database 140. The mail sender 154 may also add additional components to the message, such as, an unsubscribe link or other information necessary to adhere to CAN-SPAM regulations. Further, the mail sender 154 may determine if the email is in compliance with the privacy laws where the email is being sent. The mail sender 154 may change the email in order to ensure compliance. Once the email is generated by mail sender 154, the email system 150 sends emails to the target audience members 170 using the message transfer agent 152. The email system 150 sends the emails so that it appears as though the emails originated from the user 160 and not from the system 100.

Any emails that are not able to be delivered are handled by the bounce handler 156. The bounce handler 156 identifies the email address and the name of the target audience member 170 associated with the email that was bounced. The bounce handler 156 then communicates with the database 140 and flags the target audience member's 170 information to indicate that the email address in the database 140 may be incorrect.

After the emails are sent, in step 350, the system 100, determines which of the target audience members 170 have expressed interest in the email using the tracking service module 124. If a target audience member 170 expresses interest, in step 360, the click-to-lead processor 128 generates a marketing qualified lead by pulling information from the database 140 about the particular target audience member 170. The click-to-lead processor 128 may not always generate a lead. For example, if the budget set by the user 160 has been met, then the click-to-lead processor 128 will not generate a lead. In step 370, the activity processor 126 updates the database 140 entry for that targeted audience member 170 to reflect the targeted audience member's 170 actions.

When a marketing qualified lead is generated by the click-to-lead processor 128, the click-to-lead processor 128 stores the generated lead in a table in the user information database 130. The table includes information regarding that marketing qualified lead. The table may include the lead's name, email address, telephone number, and information about the lead's company. The user 160 is then able to download the table from the user information database 130 and obtain information on every marketing qualified lead. The system 100 may also alert the user 160 that a lead has been created or may send an email to the user 160 with the information about the lead.

After the emails are sent in step 340, the process 300 proceeds to step 344. In step 344, the process 300 waits for a set amount of time before returning to step 310. For example, the process 300 may wait for one or more hours before beginning again. The process 300 waits to allow the target audience members 170 to express interest in the marketing message and for the system 100 to generate the corresponding marketing qualified leads. If the process 300 did not wait, it would not allow time for target audience members 170 to express interest in the marketing message and become marketing qualified leads. This may result in the system 100 unnecessarily looping through. process 300 again and sending out marketing messages to additional target audience members 170. By waiting for the target audience members 170 to express interest in the marketing message, the number of marketing leads generated from an iteration of process 300 may be better determined and the number of marketing messages sent out once the process 300 begins again may be adjusted accordingly.

The system 100 is able to limit the number of emails that are sent to a target audience member 170 during a certain time period. The system 100 also does not send further emails to target audience members 170 that became leads for that marketing email: For example, if a target audience member 170 was sent an email, during subsequent iterations of process 300, the system 100 would not send the target audience member 170 another email. Also, the system 100 may recognize if a target audience member 170 was sent an email from another user and may limit the number of emails sent to one target audience member 170 over a period of time. For example, if a marketing email regarding computer equipment was sent to a target audience member 170 by the system 100, then the system 100 would not send the target audience member 170 marketing emails regarding other products or services for a period of time, such as for four. days.

An example of process 200 and 300 follows. A user 160 that produces telephone equipment wants to market his, equipment to managers at mid-size companies in Orange County, Calif. and wants 30 marketing qualified leads a week. The user 160 also decides that a target audience member 170 needs to complete a web form to qualify as a marketing qualified lead. In step 210, the user 160 interacts with the user interface module 122 and uploads a marketing message in html format to the system 100. In step 220, the user 160 indicates to the system 100 that he wants to market to managers at mid-size companies in Orange County, Calif. The system 100 informs the user 160 that there are six thousand potential target members 144 that meet that initial criteria in the database 140 and that each lead will cost ten dollars. The user 160 then sets a weekly budget of three hundred dollars because he wants thirty leads a week. In step 230, the user 160 indicates that he wants the system 100 to start generating leads in two weeks.

In step 240, the system 100 begins to parse the relevant keywords from the marketing message. In step 250, the system 100 generates a model based on the user's 160 criteria for the leads and the relevant keywords. In step 260, the system 100 sets the behavior scoring threshold at 95. After two weeks, the process 300 of generating marketing qualified leads begins with step 310. In step 310, the system 100 determines that leads are mostly generated Monday through Thursday. As a result, the system 100 sets a daily quota of seven leads for Monday through Thursday, two leads for Friday, and no leads for either Saturday or Sunday. In step 314, the system 100 determines that the quota has not been meet and proceeds to step 320.

In step 320, the model is used to score potential target audience members 144. In step 330, it is found that no potential target audience members 144 scored above the initially set threshold of ninety-five, so the process 300 proceeds to step 334. In step 334, the threshold score is lowered five points to ninety. Step 320 is then repeated and, in step 330, twenty potential target audience members 144 have scores between ninety and ninety-five. The process 300 may only classify ten of the potential target audience members 144 as target audience members 170 to ensure that only the targeted number of leads are created so that the user 160 does not spend over his set budget. Alternatively, all twenty potential members may be classified as target audience members 170. In step 340, personalized emails for ten target audience members 170 are generated by the mail sender 154 and sent to the target audience members 170 by the email system 150. In step 350, the system 100 determines that four target audience members 170 have shown interest in the email by completing a web form. In step 370, the information from the database 140 for those four target audience members 170 is updated and four leads are created in step 360 and sent to the user 160. The user 160 is charged forty dollars for the four generated leads. In step 344, the process 300 waits one hour and then returns to step 310 and on to step 314.

In step 314, the process 300 determines that the quota has not been meet and progresses to step 320. In step 320, the potential target audience members 144 are scored. In step 330, twenty of the potential target audience members 144 are found to have a score higher than the threshold score of ninety. The process 300 recognizes that ten of these potential target audience members 144 were sent an email an hour earlier. As a result, in step 330, the remaining ten potential target audience members 144 are designated as target audience members 170. In step 340, emails are personalized for the target audience members 170 and sent to them. In step 350, the system 100 recognizes that five target audience members 170 expressed interest in the email by filling out the web form. The system 100 then generates leads for those target audience members 170 in step 360. The generated leads are sent to the user 160 and the user 160 is billed fifty dollars. In step 370, the system 100 updates the database 140. In step 344, the system 100 waits for one hour and then returns to step 310 and on to step 314. In step 314, the system 100 determines that the quota has been met and proceeds to step 316.

In step 316, the system 100 waits for one day and commences again on Tuesday. On Tuesday, the system 100 reduces the quota amount by two because on Monday the system 100 generated two extra leads. Process 300 then proceeds as previously explained. As a result, system 100 is able to generate leads according to a user's 160 set criteria and only charge the user 160 for the generated leads. Further, the system 100 only generates leads and incurs fees up to a budgeted amount set by the user 160.

1. (canceled)

2. A method for producing marketing qualified leads of a target audience comprising the steps of:
receiving a marketing message in the form of an email from a user, the email containing a link;
receiving an indication of the target audience that includes information concerning the target audience industry, location, company size, and job profile from the user;
filtering a database of potential target audience members using a processor based on the received indication of the target audience;
indicating to the user the size of the target audience based on the received indication of the target audience;
receiving a budget from the user indicating the number of marketing qualified leads to generate;
parsing relevant words from the marketing message using the processor;
building a model based on the received indication of the target audience and the parsed relevant words; and
generating marketing qualified leads using the processor.

3. The method of claim 2, wherein the step of generating marketing qualified leads using the processor comprises using the model to sort through the database of potential target audience members to score each member of the potential target audience, wherein each member of the potential target audience in the database includes information based on feedback from that member and the model uses the information of each member in the database to score that member.

4. The method of claim 3, wherein the step of generating marketing qualified leads using the processor further comprises:
comparing the score of each potential target audience member to a relevancy threshold;
selecting a potential target audience member having a score above the relevancy threshold as a target member;
sending a marketing email to the target member, wherein the email includes the marketing message with the link and the target member's name;
designating the target member as a market qualified lead if the target member clicks on the link in the marketing email; and
sending the market qualified lead to the user.

5. The method of claim 4, wherein the step of generating marketing qualified leads using the processor further comprises updating the target member information in the database if the target member clicks on the link in the marketing email.

6. The method of claim 4, wherein the step of generating marketing qualified leads using the processor is repeated for a set time until the number of marketing qualified leads indicated by the budget is generated, wherein during each iteration of generating marketing qualified leads the relevancy threshold is reduced to produce new target members.

7. A method for producing marketing qualified leads of a target audience comprising the steps of:
receiving a marketing message from a user, the marketing message containing a mechanism for the target audience to indicate interest in the marketing message;
receiving an indication of the target audience that includes information corresponding to fields in a database concerning the target audience from the user;
sorting the database of potential target audience members using a processor based on the received indication of the target audience and keywords contained in the marketing message;
selecting target audience members from the sorted database of potential target audience members based on a preset budget and a threshold score;
generating marketing qualified leads using the processor.

8. The method of claim 7, wherein the step of generating marketing qualified leads using the processor comprises sending a personalized message to each of the selected target audience members, wherein the personalized message is generated from the marketing message with the respective target audience members name and the mechanism for the target audience to indicate interest in the marketing message.

9. The method of claim 8, wherein the step of generating marketing qualified leads using the processor further comprises designating the respective target audience member as a marketing qualified lead if the respective target audience member responds to the mechanism for the target audience to indicate interest in the marketing message.

10. The method of claim 9, further comprising the step of notifying the user of the marketing qualified lead and charging the user based on the number of marketing qualified leads generated.

11. The method of claim 4, wherein the step of generating marketing qualified leads using the processor is repeated for a set time until the number of marketing qualified leads indicated by the preset budget is generated, wherein during each iteration of generating marketing qualified leads the threshold score is reduced to produce new target members.

12. A system for producing marketing qualified leads of a target audience comprising:
a database storing potential target audience members;
an interface module configured to receive a marketing message in the form of an email from a user, the email containing a mechanism for the target audience to indicate interest in the marketing message, and receive an indication of the target audience that includes information corresponding to fields in the database concerning the target audience from the user; and
a processor configured to
filter the database of potential target audience members based on the received indication of the target audience, parse relevant words from the marketing message, build a model based on the received indication of the target audience and the parsed relevant words, and generate marketing qualified leads by applying the model to select target audience members from the filtered database of potential target audience members.

13. The system of claim 12, further comprising an email system configured to generate personalized emails containing the mechanism for the target audience to indicate interest in the marketing message and send the personalized emails to the target audience members based on a predetermined budget set by the user.

14. The system of claim 13, wherein the system further comprises a tracking service module configured to track the target audience members that have expressed interest in the marketing message.

15. The system of claim 14, wherein the mechanism for the target audience to indicate interest in the marketing message is a link contained in the personalized email, wherein when a respective target audience member clicks the link contained in the personalized email, the tracking service module records the respective target audience member's interest in a database.

16. The system of claim 14, wherein the mechanism for the target audience to indicate interest in the marketing message is defined as responding to the personalized email or forwarding the personalized email to a predetermined email address, and when a respective target audience members responds to the personalized email or forwards the personalized email to the predetermined email address, the tracking service module records the respective target audience members interest in a database.
